(19) United States
(12) Patent Application Publication
(10) Pub. No.: US 2025/0021303 A1
(43) Pub. Date: Jan. 16, 2025

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Taiki MIYAGAWA, Tokyo (JP)

(73) Assignee: NEC Corporation, Minato-ku, Tokyo (JP)

(21) Appl. No.: 18/712,780

(22) PCT Filed: Dec. 1, 2021
(86) PCT No.: PCT/JP2021/044010

§ 371 Date: May 23, 2024

(51) Int. Cl. G06F 7/483

(52) U.S. Cl. CPC G06F 7/4833

(57) ABSTRACT

In order to stabilize numerical computations, an information processing apparatus (1) includes an acquiring means (11) for acquiring a data set and an estimating means (12) for estimating parameters of a Fisher-Bingham distribution which corresponds to the data set, and the estimating means (12) is configured to carry out a parameter estimating process, the parameter estimating process including: calculating a logarithm of a normalizing constant C of the Fisher-Bingham distribution and a logarithm of a derivative of the normalizing constant C; calculating the linear sum of the logarithm of the normalizing constant C and the logarithm of the derivative of the normalizing constant C; and calculating an exponential function the exponent of which is the linear sum.

### TECHNICAL FIELD

The present invention relates to an information processing apparatus, an information processing method, and a program.

### BACKGROUND ART

As a distribution function on a hypersphere, the Fisher-Bingham distribution is known. The Fisher-Bingham distribution is used in distribution statistics pertaining to data on various manifolds, in particular, to data expressed on a high-dimensional sphere. For example, the Fisher-Bingham distribution is used for expressing wind directions or geomagnetism on a sphere. Further, the Fisher-Bingham distribution is used also in the field of network link prediction or the field of image generation.

As a method for estimating the parameters of the Fisher-Bingham distribution, maximum likelihood estimation in which gradient method is used is known. For example, Patent Literature 1 discloses estimating the parameters of the Fisher-Bingham distribution by maximum likelihood estimation in which parameters θ and γ are used.

### CITATION LIST

### Non-Patent Literature

### [Non-Patent Literature 1]

Chen, Yici, and Ken' ichiro Tanaka, “Maximum likelihood estimation of the Fisher-Bingham distribution via efficient calculation of its normalizing constant,” Statistics and Computing 31.4 (2021): 1-12

### SUMMARY OF INVENTION

### Technical Problem

However, there is a problem with the technique disclosed in Non-Patent Literature 1. The problem is that, in computing a logarithmic derivative of a likelihood function L in maximum likelihood estimation of the Fisher-Bingham distribution, the computation of a logarithmic derivative of a normalizing constant C(θ,γ) tends to become divergent, i.e., instability tends to be caused in numerical computations.

An example aspect of the present invention has been made in view of the above problem, and an example object thereof is to provide a technique for stabilizing numerical computations.

### Solution to Problem

An information processing apparatus in accordance with an example aspect of the present invention includes: an acquiring means for acquiring a data set; and an estimating means for estimating parameters of a Fisher-Bingham distribution which corresponds to the data set, and the estimating means is configured to carry out a parameter estimating process, the parameter estimating process including: calculating a logarithm of a normalizing constant C of the Fisher-Bingham distribution and a logarithm of a derivative of the normalizing constant C; calculating the linear sum of the logarithm of the normalizing constant C and the logarithm of the derivative of the normalizing constant C; and calculating an exponential function an exponent of which is the linear sum.

An information processing apparatus in accordance with an example aspect of the present invention includes: an acquiring means for acquiring a data set; and a calculating means for calculating log F, which is a logarithm of a target function F that at least contains, as an argument thereof, a value contained in the data set and that contains a sum of a plurality of complex terms, and given that: the plurality of complex terms are expressed as zₙ (n is an index indicating each of the plurality of complex terms); amplitudes of the zₙ are expressed as Argzₙ; and an imaginary unit is expressed as i, the calculating means is configured to calculate the log F by calculating a linear sum of log|z*|, which is a logarithm of an absolute value of z*, which is a complex term having a largest absolute value of the plurality of complex terms zₙ, and log Σ exp(log|zₙ|−log|z*|−iArgzₙ), which is a logarithm of a sum of exponential functions exponents of which are log|zₙ|−log|z*|−iArgzₙ.

An information processing method in accordance with an example aspect of the present invention includes: acquiring a data set; and estimating parameters of a Fisher-Bingham distribution which corresponds to the data set, and the estimating parameters includes: calculating a logarithm of a normalizing constant C of the Fisher-Bingham distribution and a logarithm of a derivative of the normalizing constant C; calculating a linear sum of the logarithm of the normalizing constant C and the logarithm of the derivative of the normalizing constant C; and calculating an exponential function an exponent of which is the linear sum.

An information processing method in accordance with an example aspect of the present invention includes: acquiring a data set; and calculating log F, which is a logarithm of a target function F that at least contains, as an argument thereof, a value contained in the data set and that contains a sum of a plurality of complex terms, and given that: the plurality of complex terms are expressed as zₙ (n is an index indicating each of the plurality of complex terms); amplitudes of the zₙ are expressed as Argzₙ; and an imaginary unit is expressed as i, in the calculating log F, the log F is calculated by calculating a linear sum of log|z*|, which is a logarithm of an absolute value of z*, which is a complex term having a largest absolute value of the plurality of complex terms zₙ, and log Σ exp(log|zₙ|−log|z*|−iArgzₙ), which is a logarithm of a sum of exponential functions exponents of which are log|zₙ|−log|z*|−iArgzₙ.

A program in accordance with an example aspect of the present invention is a program for causing a computer to carry out: an acquiring process of acquiring a data set; and an estimating process of estimating parameters of a Fisher-Bingham distribution which corresponds to the data set, the estimating process including: calculating a logarithm of a normalizing constant C of the Fisher-Bingham distribution and a logarithm of a derivative of the normalizing constant C; calculating a linear sum of the logarithm of the normalizing constant C and the logarithm of the derivative of the normalizing constant C; and calculating an exponential function an exponent of which is the linear sum.

A program in accordance with an example aspect of the present invention is a program for causing a computer to carry out: an acquiring process of acquiring a data set; and a calculating process of calculating log F, which is a logarithm of a target function F that at least contains, as an argument thereof, a value contained in the data set and that contains a sum of a plurality of complex terms, and given that: the plurality of complex terms are expressed as zₙ (n is an index indicating each of the plurality of complex terms); amplitudes of the zₙ are expressed as Argzₙ; and an imaginary unit is expressed as i, in the process of calculating log F, the log F is calculated by calculating a linear sum of log|z*|, which is a logarithm of an absolute value of z*, which is a complex term having a largest absolute value of the plurality of complex terms zₙ, and log Σ exp(log|zₙ|−log|z*|−iArgzₙ), which is a logarithm of a sum of exponential functions exponents of which are log|zₙ|−log|z*|−iArgzₙ.

### Advantageous Effects of Invention

With an example aspect of the present invention, it is possible to stabilize numerical computations.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of an information processing method in accordance with the first example embodiment.

FIG. 3 is a block diagram illustrating a configuration of an information processing apparatus in accordance with a second example embodiment.

FIG. 4 is a flowchart illustrating a flow of an information processing method in accordance with the second example embodiment.

FIG. 5 is a block diagram illustrating a configuration of an information processing apparatus in accordance with a third example embodiment.

FIG. 6 is a flowchart illustrating a flow of an information processing method in accordance with the third example embodiment.

FIG. 7 is a flowchart illustrating a flow of a process of calculating the derivative of log C(θ,γ) with respect to θ, in accordance with the third example embodiment.

FIG. 8 is a flowchart illustrating a flow of a process of calculating the derivative of log C(θ,γ) with respect to γ, in accordance with the third example embodiment.

FIG. 9 is a block diagram illustrating a configuration of an information processing apparatus in accordance with a fourth example embodiment.

FIG. 10 is a representation illustrating an example of a screen displayed by a display section in accordance with the fourth example embodiment.

FIG. 11 is a block diagram illustrating a configuration of a computer which functions as the information processing apparatuses in accordance with the example embodiments.

### EXAMPLE EMBODIMENTS

### First Example Embodiment

The following description will discuss a first example embodiment of the present invention in detail, with reference to the drawings. The present example embodiment is basic to example embodiments which will be described later.

### <Outline of Information Processing Apparatus 1>

An information processing apparatus 1 in accordance with the present example embodiment is an apparatus for estimating the parameters of the Fisher-Bingham distribution.

### (Outline of Fisher-Bingham Distribution)

The Fisher-Bingham distribution is defined by multivariate normal distributions constrained to lie on a unit sphere or a unit hypersphere. For p-dimensional multivariate normal distributions, the Fisher-Bingham distribution is given with use of a mean μ and a variance-covariance matrix Σ and via a density function f(x;μ,Σ) and a normalizing constant C. For x R^{p}, the density function f(x;μ,Σ) is expressed as

$$\\ f ( x ; μ , Σ ) := \frac{1}{𝒞} exp ( - \frac{{x}^{{}_{} T} {\sum }^{- 1} x}{2} + {x}^{{}_{} T} {\sum }^{- 1} μ ) {}_{} {d}_{{𝒮}^{{}_{} p - 1}} ( x )$$

where R^{p} is a p-dimensional space, and the vector x is a vector in the p-dimensional space R^{p}.

$$\\ {d}_{{𝒮}^{{}_{} p - 1}} ( x )$$

is the uniform measure of a (p−1)-dimensional space S^{p-1}.

The normalizing constant C is expressed as

$$\\ 𝒞 = 𝒞 {}_{} ( \frac{{\sum }^{- 1}}{2} , {\sum }^{- 1} μ ) := {\int }_{{𝒮}^{{}_{} p - 1}} exp ( - \frac{{x}^{{}_{} T} {\sum }^{- 1} x}{2} + {x}^{{}_{} T} {\sum }^{- 1} μ ) {}_{} {d}_{{𝒮}^{{}_{} p - 1}} ( x )$$

### <Configuration of Information Processing Apparatus 1>

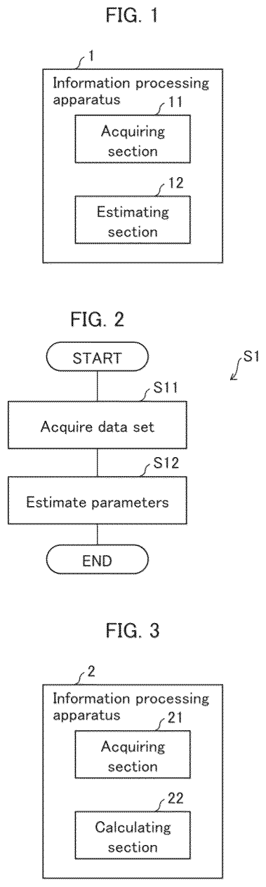

A configuration of an information processing apparatus 1 in accordance with the present example embodiment will be described below with reference to FIG. 1. FIG. 1 is a block diagram illustrating a configuration of the information processing apparatus 1. The information processing apparatus 1 includes an acquiring section 11 and an estimating section 12.

### (Acquiring Section 11)

The acquiring section 11 acquires a data set. The acquiring section 11 may acquire the data set by batch, or may acquire the data set sequentially.

### (Estimating Section 12)

The estimating section 12 estimates the parameters of a Fisher-Bingham distribution which corresponds to the data set acquired by the acquiring section 11. In this respect, the parameter estimating process carried out by the estimating section 12 includes (i) calculating the logarithm of the normalizing constant C of the Fisher-Bingham distribution and the logarithm of a derivative of the normalizing constant C, (ii) calculating the linear sum of the logarithm of the normalizing constant C and the logarithm of the derivative of the normalizing constant C, and (iii) calculating an exponential function the exponent of which is the linear sum.

As an example, the estimating section 12 estimates the parameters by maximum likelihood estimation in which gradient method is used. However, a method whereby the estimating section 12 estimates the parameters is not limited to the maximum likelihood estimation method in which gradient method is used, but may be another method. Further, as an example, the parameters estimated by the estimating section 12 include a mean μ and a variance-covariance matrix Σ.

As above, in the information processing apparatus 1 in accordance with the present example embodiment, a configuration adopted in the configuration in which a data set is acquired and the parameters of a Fisher-Bingham distribution corresponding to the acquired data set are estimated is as follows: the parameter estimating process includes calculating the logarithm of the normalizing constant C of the Fisher-Bingham distribution and the logarithm of a derivative of the normalizing constant C, calculating the linear sum of the logarithm of the normalizing constant C and the logarithm of the derivative of the normalizing constant C, and calculating an exponential function the exponent of which is the linear sum.

In a case where the numerical computations of the normalizing constant C and a derivative of the normalizing constant C are performed, there is a problem with conventional techniques, the problem being the tendency of overflow and underflow to be caused especially for high-dimensional data. According to the present example embodiment, the information processing apparatus 1 does not carry out numerical computations of the normalizing constant C and a derivative of the normalizing constant C, but carries out numerical computations of the logarithm of the normalizing constant C and the logarithm of a derivative of the normalizing constant C. Thus, with the present example embodiment, it is possible to implement numerical computations in which overflow and underflow are less likely to be caused even for high-dimensional data. In other words, the information processing apparatus 1 in accordance with the present example embodiment provides an example advantage of making it possible to stabilize numerical computations in estimating the parameters of the Fisher-Bingham distribution.

### <Flow of Information Processing Method>

A flow of an information processing method S1 in accordance with the present example embodiment will be described below with reference to FIG. 2. FIG. 2 is a flowchart illustrating a flow of the information processing method S1. In step S11, the acquiring section 11 acquires a data set. In step S12, the estimating section 12 estimates the parameters of a Fisher-Bingham distribution which corresponds to the data set. Note that, the estimation of the parameters includes calculating the logarithm of the normalizing constant C of the Fisher-Bingham distribution and the logarithm of a derivative of the normalizing constant C, calculating the linear sum of the logarithm of the normalizing constant C and the logarithm of the derivative of the normalizing constant C, and calculating an exponential function the exponent of which is the linear sum.

As above, in the information processing method S1 in accordance with the present example embodiment, a configuration adopted in the configuration in which a data set is acquired and the parameters of a Fisher-Bingham distribution corresponding to the acquired data set are estimated is as follows: the parameter estimating process includes calculating the logarithm of the normalizing constant C of the Fisher-Bingham distribution and the logarithm of a derivative of the normalizing constant C, calculating the linear sum of the logarithm of the normalizing constant C and the logarithm of the derivative of the normalizing constant C, and calculating an exponential function the exponent of which is the linear sum. Thus, the information processing method S1 in accordance with the present example embodiment provides an example advantage of making it possible to stabilize numerical computations in estimating the parameters of the Fisher-Bingham distribution.

### Second Example Embodiment

The following description will discuss a second example embodiment of the present invention in detail, with reference to the drawings. Like the first example embodiment above, the present example embodiment is basic to example embodiments which will be described later.

### <Configuration of Information Processing Apparatus>

An information processing apparatus 2 in accordance with the present example embodiment is an apparatus for calculating log F, which is the logarithm of a target function F. FIG. 3 is a block diagram illustrating a configuration of the information processing apparatus 2. The information processing apparatus 2 includes an acquiring section 21 and a calculating section 22.

### (Acquiring Section 21)

The acquiring section 21 acquires a data set. The acquiring section 11 may acquire the data set by batch, or may acquire the data set sequentially.

### (Calculating Section 22)

The calculating section 22 calculates the log F, which is the logarithm of the target function F. The target function F at least contains, as an argument thereof, a value contained in the data set acquired by the acquiring section 21. In addition, the log F contains the sum of a plurality of complex terms. As an example, the target function F is the normalizing constant of a Fisher-Bingham distribution which corresponds to the data set. However, the target function F is not limited to the above example, but may be another function.

Given that: the complex terms of the target function F are expressed as zₙ (n is an index indicating each of the complex terms); the amplitudes of zₙ are expressed as Argzₙ; and an imaginary unit is expressed as i, the calculating section 22 calculates the log F by calculating the linear sum of (i) log|z*| and (ii) log Σ exp(log|zₙ|−log|z*|−iArgzₙ). In this respect, (i) log|z*| is the logarithm of the absolute value of z*, and z* is a complex term having the largest absolute value of the plurality of complex terms zₙ. In addition, (ii) log Σ exp(log|zₙ|−log|z*|−iArgzₙ) is the logarithm of the sum of exponential functions the exponents of which are log|zₙ|−log|z*|−iArgzₙ.

The calculating section 22 calculates the log F, which is the logarithm of the target function F, by a method in which applied is the log-sum-exp trick. The log-sum-exp trick is a method of stabilizing numerical computations by factoring out, in advance, the largest one of elements which are summands and thereby limiting the range of values the elements can take on. However, since the target function F in accordance with the present example embodiment is a complex function, there is no magnitude relationship among elements (complex terms zₙ) which are summands. To address this, the calculating section 22 in accordance with the present example embodiment defines, as the largest element, an element having the largest absolute value of the complex terms zₙ, which are summands, so as to perform operations on complex numbers with use of the log-sum-exp trick.

As above, given that: the complex terms are expressed as zₙ (n is an index indicating each of the complex terms); the amplitudes of zₙ are expressed as Argzₙ; and an imaginary unit is expressed as i, the information processing apparatus 2 in accordance with the present example embodiment calculates the log F, which is the logarithm of the target function F, by calculating the linear sum of (i) log|z*| and (ii) log Σ exp(log|zₙ|−log|z*|−iArgzₙ). In this manner, the information processing apparatus 2 calculates the log F by factoring, out of the summation, a term having the largest absolute value of the complex terms zₙ contained in the target function F. Thus, the information processing apparatus 2 in accordance with the present example embodiment provides an example advantage of making it possible to stabilize numerical computations involved in calculating the logarithm of the target function F.

### <Flow of Information Processing Method>

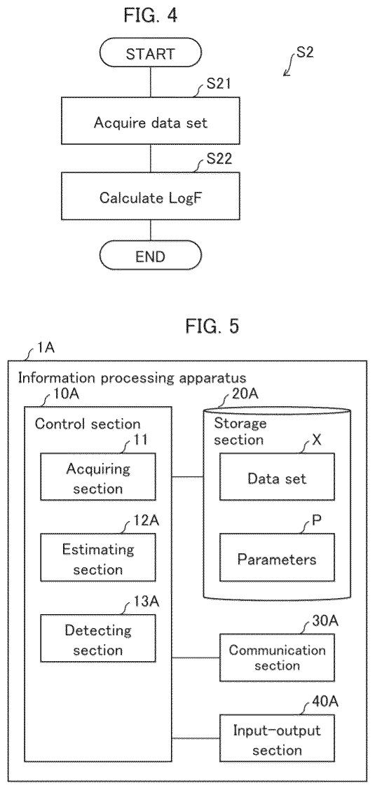

A flow of an information processing method S2 in accordance with the present example embodiment will be described below with reference to FIG. 4. FIG. 4 is a flowchart illustrating a flow of the information processing method S2. In step S21, the acquiring section 21 acquires a data set.

In step S22, the calculating section 22 calculates log F, which is the logarithm of a target function F that at least contains, as an argument thereof, a value contained in the data set and that contains the sum of a plurality of complex terms. In this respect, given that: the plurality of complex terms are expressed as zₙ (n is an index indicating each of the complex terms); the amplitudes of zₙ are expressed as Argzₙ; and an imaginary unit is expressed as i, the calculating section 22 calculates the log F by calculating the linear sum of log|z*| and log Σ exp(log|zₙ|−log|z*|−iArgzₙ), the log|z*| being the logarithm of the absolute value of z*, which is a term having the largest absolute value of the plurality of complex terms zₙ, the log Σ exp(log|zₙ|−log|z*|−iArgzₙ) being the logarithm of the sum of exponential functions the exponents of which are log|zₙ|−log|z*|−iArgzₙ.

As above, in the information processing method S2 in accordance with the present example embodiment, given that: the complex terms are expressed as zₙ (n is an index indicating each of the complex terms); the amplitudes of zₙ are expressed as Argzₙ; and an imaginary unit is expressed as i, log F which is the logarithm of the target function F is calculated by calculating the linear sum of (i) log|z*| and (ii) log Σ exp(log|zₙ|−log|z*|−iArgzₙ). Thus, the information processing method S2 in accordance with the present example embodiment provides an example advantage of making it possible to stabilize numerical computations involved in calculating the logarithm of the target function F.

### Third Example Embodiment

The following description will discuss a third example embodiment of the present invention in detail, with reference to the drawings. The same reference sign is assigned to a component that has the same function as the component described in the first example embodiment, and the description thereof is not repeated.

### <Configuration of Information Processing Apparatus 1A>

FIG. 5 is a block diagram illustrating a configuration of the information processing apparatus 1A in accordance with the present example embodiment. The information processing apparatus 1A includes a control section 10A, a storage section 20A, a communication section 30A, and an input-output section 40A.

### (Communication Section 30A)

The communication section 30A communicates with an apparatus external to the information processing apparatus 1A over a communication line. The present example embodiment is not limited to a specific configuration of the communication line, but examples of the communication line include a wireless local area network (LAN), a wired LAN, a wide area network (WAN), a public network, a mobile data communication network, and a combination thereof. The communication section 30A transmits, to another apparatus, data supplied from the control section 10A, and supplies the control section 10A with data received from another apparatus.

### (Input-Output Section 40A)

To the input-output section 40A, input-output equipment such as a keyboard, a mouse, a display, a printer, or a touch panel is connected. The input-output section 40A accepts, from the input equipment connected thereto, input of various kinds of information to the information processing apparatus 1A. In addition, the input-output section 40A outputs various kinds of information to the output equipment connected thereto, under the control of the control section 10A. Examples of the input-output section 40A include an interface such as a universal serial bus (USB).

### (Control Section 10A)

The control section 10A includes an acquiring section 11, an estimating section 12A, and a detecting section 13A, as illustrated in FIG. 5.

### (Acquiring Section 11)

The acquiring section 11 acquires a data set X. As an example, the acquiring section 11 acquires the data set X from another apparatus via the communication section 30A. As another example, the acquiring section 11 may acquire the data set X which is inputted via the input-output section 40A. Alternatively, the acquiring section 11 may acquire the data set X by retrieving the data set X from the storage section 20A or externally connected storage.

### (Estimating Section 12A)

The estimating section 12A estimates the parameters of a Fisher-Bingham distribution which corresponds to the data set X acquired by the acquiring section 11. The details of an estimating process carried out by the estimating section 12A will be described later. The estimating section 12A is an example of the estimating means and the calculating means in accordance with the present application.

### (Detecting Section 13A)

The detecting section 13A refers to parameters estimated by the estimating section 12A, to carry out a detecting process pertaining to the data set X. The details of the detecting process carried out by the detecting section 13A will be described later.

### (Storage Section 20A)

In the storage section 20A, the data set X acquired by the acquiring section 11 is stored, and parameters P of the Fisher-Bingham distribution is also stored. As an example, the parameters P include a mean μ and a variance-covariance matrix Σ.

### <Flow of Information Processing Method Carried Out by Information Processing Apparatus 1A>

A flow of an information processing method carried out by the information processing apparatus 1A configured as described above will be described below with reference to the drawings. In the present example embodiment, the information processing apparatus 1A estimates the parameters of the Fisher-Bingham distribution by maximum likelihood estimation in which gradient method is used. As an example, the information processing apparatus 1A updates parameters θ and γ, and a matrix O of a likelihood function L(θ,γ,O) until the variations of the parameters θ, γ, and \hat{ }v become sufficiently small. Note that the representation “\hat{ }v” represents “v-hat”.

The parameters θ and γ are expressed respectively as:

$$\\ \begin{matrix}θ = ( {θ}_{1} , … , {θ}_{p} ) = diag ( \frac{{Δ}^{- 1}}{2} ) & ( Equation 0 ‐ 1 )\end{matrix}$$

$$\\ γ = ( {γ}_{1} , … , {γ}_{p} ) = {Δ}^{- 1} O μ$$

where each Δ is a diagonal matrix, and O is an orthogonal matrix. The parameter \hat{ }v is a parameter used in the process of updating the matrix O.

### (Likelihood Function L(θ,γ,O))

Prior to the description of a flow of the information processing method carried out by the information processing apparatus 1A, the likelihood function L(θ,γ,O) used in maximum likelihood estimation will be described first. With use of the data set X=(x₁, x₂, . . . , xₙ) R^{p×n} (p is the number of dimensions, and n is the number of pieces of data),

$$\\ A = \frac{{\sum }_{i = 1}^{n} {x}_{i} {x}_{i}^{{}_{} T}}{n} , and B = \frac{{\sum }_{i = 1}^{n} {x}_{i}}{n} ,$$

the likelihood function L(θ,γ,O) is expressed as

$$\\ log {}_{} ℒ {}_{} ( \frac{{\sum }^{- 1}}{2} , {\sum }^{- 1} μ , X ) = log {\prod }_{i = 1}^{n} ( \frac{exp ( {x}_{i}^{{}_{} T} {\sum }^{- 1} μ - \frac{{x}_{i}^{{}_{} T} {\sum }^{- 1} {x}_{i}}{2} )}{𝒞 ( \frac{{\sum }^{- 1}}{2} , {\sum }^{- 1} μ )} ) = - n log 𝒞 ( \frac{{Δ}^{- 1}}{2} , γ ) - {\sum }_{i = 1}^{n} ( {x}_{i}^{{}_{} T} \frac{{\sum }^{- 1}}{2} {x}_{i} - {x}_{i}^{{}_{} T} {\sum }^{- 1} μ ) = - nlog 𝒞 ( \frac{{Δ}^{- 1}}{2} , γ ) - ntr ( {AO}^{{}_{} T} \frac{{Δ}^{- 1}}{2} O - OB {γ}^{{}_{} T} ) = - n ( log 𝒞 ( θ , γ ) + tr ( {AO}^{{}_{} T} diag ( θ ) O + OB {γ}^{{}_{} T} ) )$$

where

$$\\ \begin{matrix}{\sum }^{- 1} = {O}^{{}_{} T} {Δ}^{- 1} O , & ( Equation 0 ‐ 2 )\end{matrix}$$

$$\\ 𝒞 {}_{} ( \frac{{\sum }^{- 1}}{2} , {\sum }^{- 1} μ ) = 𝒞 {}_{} ( \frac{{Δ}^{- 1}}{2} , γ ) = 𝒞 ( θ , γ ) , γ = {Δ}^{- 1} O μ , and$$

$$\\ \begin{matrix}\frac{{Δ}^{- 1}}{2} = diag ( θ ) & ( Equation 0 ‐ 3 )\end{matrix}$$

Further,

[symbol]

is a moment-generating function.

Therefore, maximizing the likelihood function

$$\\ log {}_{} ℒ {}_{} ( \frac{{\sum }^{- 1}}{2} , {\sum }^{- 1} μ , X )$$

is equivalent to maximizing the following.

$$\\ log L ( θ , γ , O ) := log 𝒞 ( θ , γ ) + tr ( {AO}^{{}_{} T} diag ( θ ) O + OB {γ}^{{}_{} T} )$$

Further,

$$\\ log L ( θ , γ , O ) = - \frac{1}{n} log {}_{} ℒ {}_{} ( \frac{{\sum }^{- 1}}{2} , {\sum }^{- 1} μ , X )$$

### (Normalizing Constant C(θ,γ))

The log L(θ,γ,O) contains the normalizing constant C(θ,γ). With use of parameters p, q, h, and N which are defined by a user, and given

$$\\ w ( x ; p , q ) = \frac{1}{2} erfc ( \frac{x}{p} - q ) ,$$

the normalizing constant C(θ,γ) is expressed as

$$\begin{matrix}𝒞 ( θ , γ ) = {π}^{\frac{p}{2} - 1} {e}^{- {t}_{0}} {\int }_{ℝ} 𝒜 ( t ; θ , γ ) {e}^{it} dt \\ \approx {π}^{\frac{p}{2} - 1} {e}^{- {t}_{0}} {\int }_{ℝ} w ( \vert t \vert , p , q ) 𝒜 ( t ; θ , γ ) {e}^{it} dt \\ \approx {π}^{\frac{p}{2} - 1} {e}^{- {t}_{0}} h {\sum }_{n = - N - 1}^{N} w ( \vert nh \vert ; p , q ) 𝒜 ( nh ; θ , γ ) {e}^{inh} \\ \text{=:} {𝒞}_{w}^{( N , h )} ( θ , γ ) ,\end{matrix}$$

where
[symbol] (t;θ,γ)
   and t correspond to the Fourier transform of the normalizing constant C and the dummy variable.

### (θ-Derivative, γ-Derivative of Normalizing Constant C(θ,γ))

According to the present example embodiment, the estimating section 12A uses the derivative of the normalizing constant C(θ,γ) with respect to θ and the derivative of the normalizing constant C(θ,γ) with respect to γ, to update the parameters θ and γ, and O. The derivative of the normalizing constant C(θ,γ) with respect to θ is expressed as the following (Equation 1).

$$\begin{matrix}{𝒞}_{{θ}_{i}} ( θ , γ ) := \frac{\partial 𝒞 ( θ , γ )}{\partial {θ}_{i}} \\ = {π}^{\frac{p}{2} - 1} {e}^{- {t}_{0}} {\int }_{ℝ} \frac{\partial 𝒜 ( t ; θ , γ )}{\partial {θ}_{i}} {e}^{it} dt .\end{matrix} \qquad ( Equation 1 )$$

In addition, the derivative of the normalizing constant C(θ,γ) with respect to γ is expressed as the following (Equation 2).

$$\begin{matrix}{𝒞}_{{γ}_{i}} ( θ , γ ) := \frac{\partial 𝒞 ( θ , γ )}{\partial {γ}_{i}} \\ = {π}^{\frac{p}{2} - 1} {e}^{{t}_{0}} {\int }_{ℝ} \frac{\partial 𝒜 ( t ; θ , γ )}{\partial {γ}_{i}} {e}^{it} dt\end{matrix} \qquad ( Equation 2 )$$

By applying continuous Euler transform to (Equation 1) above, the derivative of the normalizing constant C(θ,γ) with respect to θ is expressed as the following (Equation 3).

$$\begin{matrix}{𝒞}_{{θ}_{i}} ( θ , γ ) = {π}^{\frac{p}{2} - 1} {e}^{- {t}_{0}} {\int }_{ℝ} {𝒜}_{{θ}_{i}} ( t ; θ , γ ) {e}^{it} dt \\ \approx {π}^{\frac{p}{2} - 1} {e}^{- {t}_{0}} h {\sum }_{n = - N - 1}^{N} w ( \vert nh \vert ; p , q ) {𝒜}_{{θ}_{i}} ( nh ; θ , γ ) {e}^{inh}\end{matrix} \qquad ( Equation 3 )$$

In addition, by applying the continuous Euler transform to (Equation 2) above, the derivative of the normalizing constant C(θ,γ) with respect to γ is expressed as the following (Equation 4):

$$\begin{matrix}{𝒞}_{{γ}_{i}} ( θ , γ ) = {π}^{\frac{p}{2} - 1} {e}^{- {t}_{0}} {\int }_{ℝ} {𝒜}_{{γ}_{i}} ( t ; θ , γ ) {e}^{it} dt \\ \approx {π}^{\frac{p}{2} - 1} {e}^{- {t}_{0}} h {\sum }_{n = - N - 1}^{N} w ( \vert nh \vert ; p , q ) {𝒜}_{{γ}_{i}} ( nh ; θ , γ ) {e}^{inh}\end{matrix} \qquad ( Equation 4 )$$

### (Flow of Information Processing Method S1A)

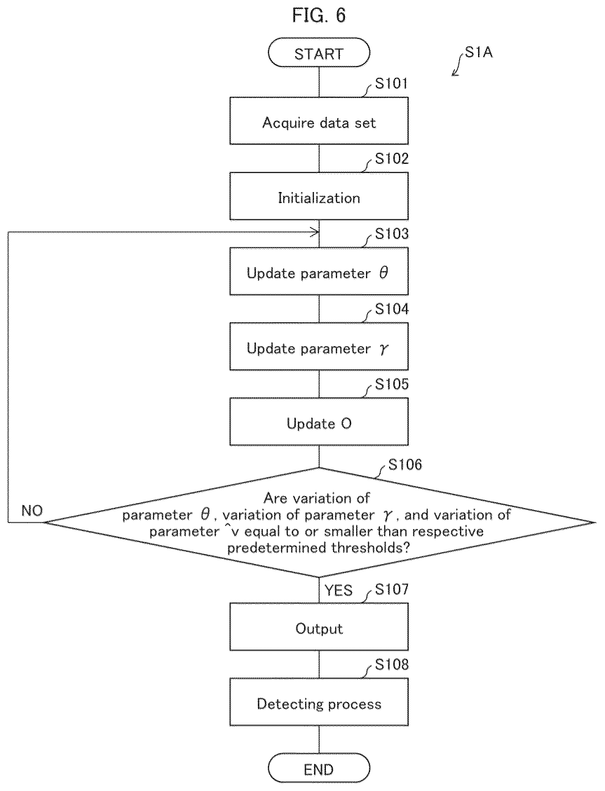

FIG. 6 is a flowchart illustrating a flow of an information processing method S1A, which is an example of the information processing method carried out by the information processing apparatus 1A. It should be noted that description of the content already described above will not be repeated. In this example, the parameters estimated by the estimating section 12A include the parameters θ and γ, and the matrix O. In the information processing method S1A, the estimating section 12A repeatedly updates the parameters θ and r, and the matrix O, and thereby optimizes log L(θ,γ,O).

### (Step S101)

In step S101, the acquiring section 11 acquires a data set X. As an example, the acquiring section 11 may receive the data set X from another apparatus via the communication section 30A, or may acquire the data set X inputted via the input-output section 40A. Alternatively, the acquiring section 11 may acquire the data set X by retrieving the data set X from the storage section 20A or external storage.

### (Step S102)

First, in step S102, the estimating section 12A carries out an initializing process. As an example, the estimating section 12A initializes the parameters θ and γ, and the matrix O. Parameters initialized by the estimating section 12A in step S102 are not limited to these parameters, and the estimating section 12A may initialize another parameter.

### (Step S103)

In step S103, the estimating section 12A uses the likelihood function L(θ,γ,O), to update the parameter θ, which is one of the parameters of the Fisher-Bingham distribution, by

$$\hat{θ} = θ + \frac{\partial log L ( θ , γ , 𝒪 )}{\partial θ} {δ}_{θ} .$$

In this respect, δ_{θ} is a parameter which defines the extent of the update of the parameter θ. As an example, δ_{θ} can be a sufficiently small value. As an example, δ_{θ} is a real number which satisfies the following.

$$log L ( \hat{θ} , γ , 𝒪 ) < log L ( θ , γ , 𝒪 )$$

The derivative of the log L(θ,γ,O) with respect to θ is obtained by substituting (Equation 3) above into the following.

$$\frac{\partial log L ( θ , γ , 𝒪 )}{\partial θ} = \frac{\partial 𝒞 ( θ , γ )}{\partial θ} \frac{1}{𝒞 ( θ , γ )} + diag ( 𝒪 A {𝒪}^{T} )$$

The estimating section 12A calculates the following derivative, with respect to θ, of the log C(θ,γ), which is the logarithm of the normalizing constant C(θ,γ) contained in the log L(θ,γ,O):

$$\frac{\partial 𝒞 ( θ , γ )}{\partial θ} \frac{1}{𝒞 ( θ , γ )}$$

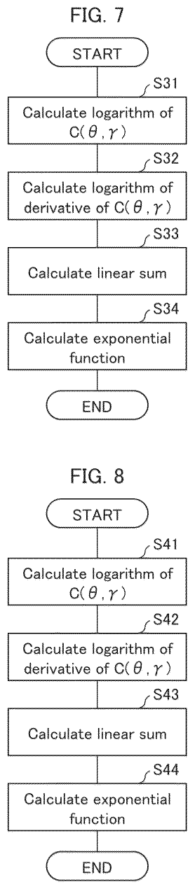

by carrying out steps S31 to S34 of FIG. 7. FIG. 7 is a flowchart illustrating an example of the process of calculating the derivative of the log C(θ,γ) with respect to θ. The calculating process illustrated in FIG. 7 includes steps S31 to S34.

### (Step S31)

In step S31, the estimating section 12A calculates log C(θ,γ), which is the logarithm of the normalizing constant C(θ,γ). The normalizing constant C(θ,γ) is an example of the target function in accordance with the present application. In other words, according to the present example embodiment, the target function is the normalizing constant of a Fisher-Bingham distribution which corresponds to the data set.

Further, the log C(θ,γ), which is the logarithm of the normalizing constant C(θ,γ), contains the sum of a plurality of complex terms. In this respect, given that: the plurality of complex terms of the log C(θ,γ) are expressed as zₙ (n is an index indicating each of the complex terms); the amplitudes of zₙ are expressed as Argzₙ; and an imaginary unit is expressed as i, the estimating section 12A calculates the log C(θ,γ) by calculating the linear sum of log|z* and log Σ exp(log|zₙ|−log|z*|−iArgzₙ), the log|z*| being the logarithm of the absolute value of z*, which is a term having the largest absolute value of the plurality of complex terms zₙ, the log Σ exp(log|zₙ|−log|z*|−iArgzₙ) being the logarithm of the sum of exponential functions the exponents of which are log|zₙ|−log|z*|−iArgzₙ. Specifically, as an example, the log C(θ,γ) is calculated by the following (Equation 5):

$$log 𝒞 ( θ , γ ) = ( \frac{p}{2} - 1 ) log π + {t}_{0} + log \vert {z}_{n} \vert + log {\sum }_{n = - N - 1}^{N} {e}^{log \vert {z}_{n} \vert - log \vert z \text{?} \vert + \text{?}} \qquad ( Equation 5 )$$

$$\text{?} \text{indicates text missing or illegible when filed}$$

In the above equation, to is a parameter defined by a user. Further, the complex terms zₙ of (Equation 5) are as follows.

$${z}_{n} := hw ( \vert nh \vert ; p , q ) 𝒜 ( nh , θ , γ ) {e}^{inh} ∈ ℂ$$

The first term (p/2−1)log π of the right side of (Equation 5) does not contain an exponential function. Thus, this term does not diverge even for large p. Furthermore, in (Equation 5), performing the subtraction log|zₙ|−log|z*| prevents both of the real and imaginary parts of the elements of summation from becoming very large values.

### (Step S32)

In step S32, the estimating section 12A calculates the following logarithm of the derivative of the normalizing constant C(θ,γ).

$$log \frac{\partial 𝒞 ( θ , γ )}{\partial θ}$$

A derivative of the normalizing constant C(θ,γ) is an example of the target function in accordance with the present application. The logarithm of a derivative of the normalizing constant C(θ,γ) contains the sum of a plurality of complex terms. Further, given that: the plurality of complex terms of the logarithm of the derivative of the normalizing constant C(θ,γ) are expressed as zₙ (n is an index indicating each of the complex terms); the amplitudes of zₙ are expressed as Argzₙ; and an imaginary unit is expressed as i, the estimating section 12A calculates the logarithm of a derivative of the normalizing constant C(θ,γ) by calculating the linear sum of log|z*| and log Σ exp(log|zₙ|−log|z*|−iArgzₙ), the log|z*| being the logarithm of the absolute value of z*, which is a term having the largest absolute value of the plurality of complex terms zₙ, the log Σ exp(log|zₙ|−log|z*|−iArgzₙ) being the logarithm of the sum of exponential functions the exponents of which are log|zₙ|−log|z*|−iArgzₙ. Specifically, as an example, the logarithm of the derivative of the normalizing constant C(θ,γ) is calculated by the following (Equation 6).

$$log \frac{\partial 𝒞 ( θ , γ )}{\partial θ} = ( \frac{p}{2} - 1 ) log π + {t}_{0} + log \vert {z}_{n} \vert + log {\sum }_{n = - N - 1}^{N} {e}^{log \vert {z}_{n} \vert - log \vert z \text{?} \vert + \text{?}} \qquad ( Equation 6 )$$

$$\text{?} \text{indicates text missing or illegible when filed}$$

The complex terms zₙ of (Equation 6) are as follows.

$${z}_{n} := hw ( \vert nh \vert ; p , q ) {𝒜}_{{θ}_{i}} ( nh , θ , γ ) {e}^{inh} ∈ ℂ$$

The first term (p/2−1)log π of the right side of (Equation 6) does not contain an exponential function. Thus, this term does not diverge even for large p. Furthermore, in (Equation 6), performing the subtraction log|zₙ|−log|z*| prevents both of the real and imaginary parts of the elements of summation from becoming very large values.

### (Step S33)

In step S33, the estimating section 12A calculates the following linear sum of the logarithm of the normalizing constant C(θ,γ) calculated in step S31 and the logarithm of the derivative of the normalizing constant C(θ,γ) calculated in step S32.

$$- log 𝒞 ( θ , γ ) + log \frac{\partial 𝒞 ( θ , γ )}{\partial θ}$$

### (Step S34)

In step S34, the estimating section 12A calculates an exponential function the exponent of which is the linear sum calculated in step S33. The exponential function calculated by the estimating section 12A in step S34 is the derivative of the log C(θ,γ) with respect to θ.

### (Step S104)

Furthermore, in step S104 of FIG. 6, the estimating section 12A uses a likelihood function L(θ,γ,O) to update γ, which is one of the parameters of the Fisher-Bingham distribution, by the following:

$$\hat{γ} = γ + \frac{\partial log L ( θ , γ , O )}{\partial γ} δγ$$

where, δ_{γ} is a parameter which specifies the extent of the update of the parameter γ. As an example, δ_{γ} can be a sufficiently small value. As an example, δ_{γ} is a real number which satisfies the following:

$$log L ( θ , \hat{γ} , O ) < log L ( θ , γ , O )$$

The derivative of the log L(θ,γ,O) with respect to γ is obtained by substituting (Equation 4) above into the following:

$$\frac{\partial log L ( θ , γ , O )}{\partial γ} = \frac{\partial C ( θ , γ )}{\partial γ} \frac{1}{C ( θ , γ )} + {B}^{T} {O}^{T}$$

The estimating section 12A calculates the following derivative, with respect to γ, of the log C(θ,γ), which is the logarithm of the normalizing constant C(θ,γ) contained in the log L(θ,γ,O):

$$\frac{\partial C ( θ , γ )}{\partial γ} \frac{1}{C ( θ , γ )}$$

by carrying out the calculating process illustrated in FIG. 8. FIG. 8 is a flowchart illustrating an example of the process of calculating the derivative of the log C(θ,γ) with respect to γ. The calculating process illustrated in FIG. 8 includes steps S41 to S44.

### (Step S41)

In step S41, the estimating section 12A calculates log C(θ,γ), which is the logarithm of the normalizing constant C(θ,γ). The details of the process of step S41 are the same as the details of step S31 described above, and the description thereof is not repeated here.

### (Step S42)

In step S42, the estimating section 12A calculates the following logarithm of a derivative of the normalizing constant C(θ,γ).

$$log \frac{\partial C ( θ , γ )}{\partial γ}$$

A derivative of the normalizing constant C(θ,γ) is an example of the target function in accordance with the present application. The logarithm of a derivative of the normalizing constant C(θ,γ) contains the sum of a plurality of complex terms. Further, given that: the plurality of complex terms of the logarithm of the derivative of the normalizing constant C(θ,γ) are expressed as zₙ (n is an index indicating each of the complex terms); the amplitudes of zₙ are expressed as Argzₙ; and an imaginary unit is expressed as i, the estimating section 12A calculates the logarithm of a derivative of the normalizing constant C(θ,γ) by calculating the linear sum of log|z*| and log Σ exp(log|zₙ|−log|z*|−iArgzₙ), the log|z*| being the logarithm of the absolute value of z*, which is a term having the largest absolute value of the plurality of complex terms zₙ, the log Σ exp(log|zₙ|−log|z*|−iArgzₙ) being the logarithm of the sum of exponential functions the exponents of which are log|zₙ|−log|z*|−iArgzₙ. Specifically, as an example, the logarithm of the derivative of the normalizing constant C(θ,γ) is calculated by the following Equation.

$$log \frac{\partial C ( θ , γ )}{\partial γ} = ( \frac{p}{2} - 1 ) log π + {t}_{0} + log \vert {z}_{\text{?}} \vert + log {\sum }_{n = - N - 1}^{N} {e}^{log \vert {z}_{\text{?}} \vert - log \vert {z}_{\text{?}} \vert + iArg {z}_{n}}$$

$$\text{?} \text{indicates text missing or illegible when filed}$$

The complex terms zₙ of the above equation are as follows.

$${z}_{n} := hw ( \vert nh \vert ; p , q ) {𝒜}_{γ i} ( nh , θ , γ ) {e}^{inh} ∈ ℂ$$

### (Step S43)

In step S43, the estimating section 12A calculates the following linear sum of the logarithm of the normalizing constant C(θ,γ) calculated in step S41 and the logarithm of the derivative of the normalizing constant C(θ,γ) calculated in step S42.

$$- log C ( θ , γ ) + log \frac{\partial C ( θ , γ )}{\partial γ}$$

### (Step S44)

In step S44, the estimating section 12A calculates an exponential function the exponent of which is the linear sum calculated in step S44. The exponential function calculated by the estimating section 12A in step S44 is the derivative of the log C(θ,γ) with respect to γ.

### (Step S105)

In step S105 of FIG. 6, the estimating section 12A updates the parameter O, which is one of the parameters of the Fisher-Bingham distribution, by the following:

$$\hat{O} = {e}^{\hat{v} {t}_{0}} O$$

where \hat{ }v is obtained by substituting

$$𝒜 = diag ( θ ) {OAO}^{T} - {OAO}^{T} diag ( θ ) + γ {B}^{T} {O}^{T}$$

into the following.

$$\hat{v} = 𝒜 - {𝒜}^{T}$$

Further, t₀ is a real number which satisfies the following.

$$log L ( θ , γ , \hat{O} ) < log L ( θ , γ , O )$$

### (Step S106)

In step S106, the estimating section 12A judges whether the variation of the parameter θ, the variation of the parameter γ, and the variation of the parameter \hat{ }v are equal to or smaller than respective predetermined thresholds. In this judgment, for parameters θ, γ, and \hat{ }v, different thresholds may be used, or a common threshold may be used. In a case where the variation of θ, the variation of γ, and the variation of \hat{ }v are equal to or smaller than the thresholds (YES in step S106), the estimating section 12A proceeds to the process of step S107. In a case where any of the variation of θ, the variation of γ, and the variation of \hat{ }v is not equal to or smaller than the corresponding threshold (NO in step S106), the estimating section 12A returns to step S103, to continues to update the parameters θ, γ, and O.

### (Step S107)

In step S107, the estimating section 12A outputs the parameters estimated. The parameters outputted by the estimating section 12A may include the parameters θ, γ, and O, or may include a mean μ and a variance-covariance matrix Σ which are defined by the parameters θ, γ, and O. The relationship of the mean μ and the variance-covariance matrix E with the parameters θ and γ and the matrix O is given by the above described (Equation 0-1), (Equation 0-2), and (Equation 0-3).

The estimating section 12A may output the parameters by writing the parameters in the storage section 20A or external storage, or may output to output equipment (such as a display or a printer) connected to the input-output section 40A. Further, the estimating section 12A may transmit the parameters to another apparatus via the communication section 30A.

### (Step S108)

In step S108, the detecting section 13A refers to the parameters estimated by the estimating section 12A, to carry out a detecting process pertaining to the data set X. For example, the detecting section 13A may perform an anomaly detection process or a behavior detection process on time-series data. More specifically, as an example, the detecting section 13A performs temporal localization (TL) of assigning a class label to each element data contained in the time-series data. In this case, as an example, the time-series data is moving image data, and the class label is a label which indicates an event being taking place and the time at which the event is taking place. As an example, for each element data contained in the time-series data, the detecting section 13A detects a change point of the time-series data with use of the Fisher-Bingham distribution estimated by the estimating section 12A. However, the detecting process carried out by the detecting section 13A is not limited to the above example, and may be another detecting process. For example, the detecting section 13A may carry out the process (speaker diarization) of detecting, from conversation audio data, a person being speaking and the time at which the person is speaking.

### <Example Advantage of Information Processing Apparatus 1A>

As above, in the information processing apparatus 1A in accordance with the present example embodiment, the parameter θ is updated with use of the likelihood function L(θ,γ,O). In this updating process, the information processing apparatus 1A does not directly perform numerical computation of the product of a derivative of a normalizing constant C(θ,γ) and the reciprocal of the normalizing constant C(θ,γ), but performs separate computations of (i) the logarithm of the normalizing constant C(θ,γ) and (ii) the logarithm of a derivative of the normalizing constant C(θ,γ) and calculates an exponential function the exponent of which is the linear sum of these logarithms, to calculate the derivative of log C(θ,γ) with respect to θ. Thus, according to the present example embodiment, it is possible to stabilize numerical computations in estimating the parameters of the Fisher-Bingham distribution with use of a parameter θ. That is, it is possible to carry out the numerical computation of dividing a derivative of a normalizing constant C by the normalizing constant C, without directly handling large values and nearly zero values on a computer. According to the present example embodiment, by performing such numerical computations, it is possible to stably perform the numerical computation of a gradient required for maximum likelihood estimation.

In addition, in the information processing apparatus 1A in accordance with the present example embodiment, the parameter γ is updated with use of the likelihood function L(θ,γ,O). In this updating process, the information processing apparatus 1A calculates the derivative, with respect to γ, of log C(θ,γ), which is the logarithm of the normalizing constant C, by calculating an exponential function the exponent of which is the linear sum of (i) the logarithm of the normalizing constant C(θ,γ) and the logarithm of a derivative of the normalizing constant C(θ,γ). Thus, according to the present example embodiment, it is possible to stabilize numerical computations in estimating the parameters of the Fisher-Bingham distribution with use of a parameter γ.

Further, in the information processing apparatus 1A in accordance with the present example embodiment, the logarithms of target functions (normalizing constant C, a derivative of the normalizing constant C) are log-sum-exp-type complex functions. Furthermore, the information processing apparatus 1A defines, in the log-sum-exp trick, the “largest element in summation” as an “element having the largest absolute value of the elements of summation”, to perform operations with use of a log-sum-exp trick method intended for complex numbers. Specifically, as an example, the information processing apparatus 1A calculates log C(θ,γ) by calculating the linear sum of log|z*| and log Σ exp(log|zₙ|−log|z*|−iArgzₙ). In this manner, by factoring out, in advance, the logarithm of the absolute value of a term having the largest absolute value of a plurality of complex terms zₙ, it is possible to avoid overflow and underflow in calculating the logarithms of the target functions. This makes it possible to stabilize numerical computations.

In addition, in the information processing apparatus 1A in accordance with the present example embodiment, the detecting section 13A uses parameters estimated by the estimating section 12A, to carry out a detecting process pertaining to the data set X. Thus, according to the present example embodiment, it is possible to stabilize numerical computations involved in the detecting process pertaining to the data set X.

### <Example Application>

In a case where, for specific x, μ, and Σ, the following density function of the Fisher-Bingham distribution:

$$f ( x ; μ , \sum ) = \frac{1}{C ( γ , O )} {e}^{- \frac{{x}^{T} {\sum }^{- 1} x}{2}} + {x}^{T} {\sum }^{- 1} μ$$

is calculated, both of the values of the normalizing constant C(θ,γ) and the exponential function exp can become large. When both the normalizing constant C(θ,γ) and the exponential function exp are large, the accuracy of computation suffers. To address this, the information processing apparatus 1A takes the logarithm of the density function f(x;μ,Σ), and as indicated by the following:

$$log f ( x ; μ , \sum ) = - log C ( γ , θ ) - \frac{{x}^{T} {\sum }^{- 1} x}{2} + {x}^{T} {\sum }^{- 1} μ ,$$

log C and the exponent of the exponential function exp are separated from each other so as to be separately computed, and an exponential function the exponent of which is the result of computation may be computed. This makes it possible to stably obtain the density function f from the perspective of numerical values.

### Fourth Example Embodiment

The following description will discuss a fourth example embodiment of the present invention in detail, with reference to the drawings. The same reference sign is assigned to a component that has the same function as the component described in the first to third example embodiments, and the description thereof is not repeated.

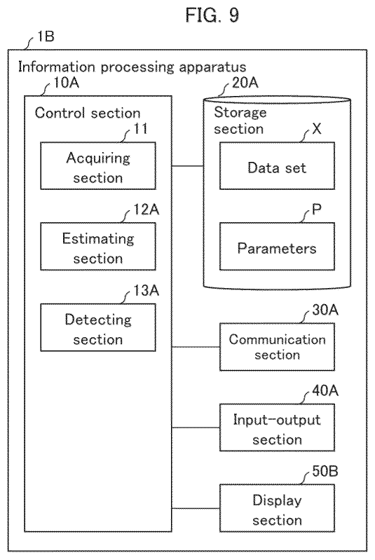

FIG. 9 is a block diagram illustrating a configuration of an information processing apparatus 1B in accordance with the present example embodiment. The information processing apparatus 1B includes a display section 50B, in addition to a control section 10A, a storage section 20A, a communication section 30A, and an input-output section 40A. The display section 50B displays various types of information on the basis of data supplied by the control section 10A. As an example, the display section 50B displays parameters estimated by an estimating section 12A.

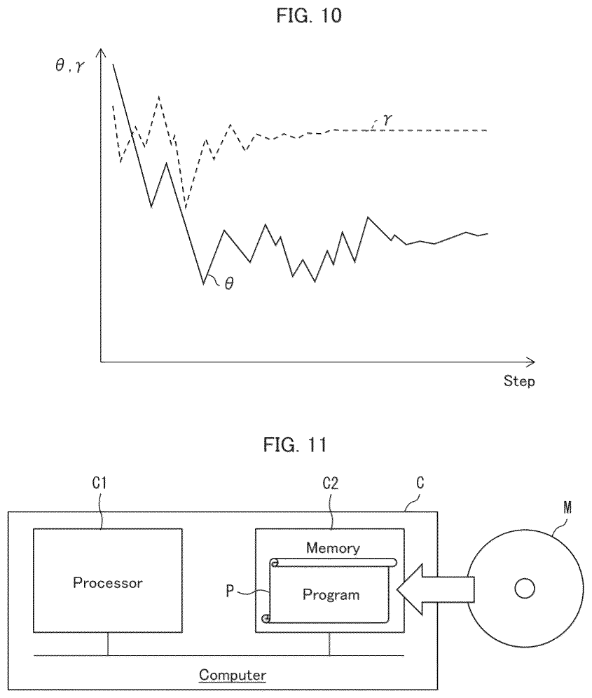

FIG. 10 is a representation illustrating an example of a screen displayed by the display section 50B. In the example of FIG. 10, the display section 50B displays, on the basis of the data supplied by the control section 10A, graphs which represent parameters θ and γ updated by the estimating section 12A. For the graphs of FIG. 10, the horizontal axis indicates the number of steps, and the vertical axis indicates the value of one component of each of θ and γ. According to the present example embodiment, computation proceeds without divergence. Therefore, as the step advances, the above component of θ suitably converges to a certain value and the above component of parameter γ also suitably converges to another value. The display section 50B may display a graph of another component of each of the parameters θ and γ, the graph being similar to that of the above component. In other words, the display section 50B may display a graph for each of the components of each of the parameters θ and γ.

### [Software Implementation Example]

Some or all of the functions of each of the information processing apparatuses 1, 1A, and 2 may be implemented by hardware such as an integrated circuit (IC chip), or may be implemented by software.

In the latter case, the information processing apparatuses 1, 1A, and 2 are each implemented by, for example, a computer that executes instructions of a program that is software implementing the foregoing functions. An example (hereinafter, computer C) of such a computer is illustrated in FIG. 8. The computer C includes at least one processor C1 and at least one memory C2. The memory C2 has recorded thereon a program P for causing the computer C to operate as the information processing apparatuses 1, 1A, and 2. The processor C1 of the computer C retrieves and executes the program P from the memory C2, so that the functions of the information processing apparatuses 1, 1A, and 2 are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted through a transmission medium. Examples of such a transmission medium can include a communication network and a broadcast wave. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

An information processing apparatus including:
an acquiring means for acquiring a data set; and
an estimating means for estimating parameters of a Fisher-Bingham distribution which corresponds to the data set,
the estimating means being configured to carry out a parameter estimating process, the parameter estimating process including:
   calculating a logarithm of a normalizing constant C of the Fisher-Bingham distribution and a logarithm of a derivative of the normalizing constant C;
   calculating the linear sum of the logarithm of the normalizing constant C and the logarithm of the derivative of the normalizing constant C; and
   calculating an exponential function an exponent of which is the linear sum.

With this configuration, it is possible to stabilize numerical computations in estimating the parameter of the Fisher-Bingham distribution.

### (Supplementary Note 2)

The information processing apparatus described in supplementary note 1, in which
the estimating means is configured to:
   estimate the parameters by maximum likelihood estimation in which gradient method is used;
   with use of a likelihood function L(θ,γ,O), update θ, which is one of the parameters, by

$$\hat{θ} = θ + \frac{\partial log L ( θ , γ , O )}{\partial θ} {δ}_{0} ;$$

and
calculate a derivative, with respect to θ, of log C(θ,γ), which is a logarithm of C(θ,γ), which is the normalizing constant C contained in the log L(θ,γ,O), the derivative being expressed as

$$\\ \frac{\partial 𝒞 ( θ , γ )}{\partial θ} \frac{1}{𝒞 ( θ , γ )} ,$$

by calculating the log C(θ,γ), which is the logarithm of the normalizing constant C(θ,γ), and a logarithm of a derivative of the normalizing constant C(θ,γ) expressed as

$$\\ log \frac{\partial 𝒞 ( θ , γ )}{\partial θ} ,$$

calculating the linear sum of the logarithm of the normalizing constant C(θ,γ) and the logarithm of the derivative of the normalizing constant C(θ,γ), the linear sum being expressed as

$$\\ - log 𝒞 ( θ , γ ) + log \frac{\partial 𝒞 ( θ , γ )}{\partial θ} ,$$

and
calculating the exponential function an exponent of which is the linear sum.

With this configuration, it is possible to stabilize numerical computations in estimating the parameters of the Fisher-Bingham distribution with use of a parameter θ.

### (Supplementary Note 3)

The information processing apparatus described in supplementary note 1 or 2, in which
the estimating means is configured to:
   estimate the parameters by maximum likelihood estimation in which gradient method is used;
   with use of a likelihood function L(θ,γ,O), update γ, which is one of the parameters, by

$$\\ \hat{γ} = γ + \frac{\partial log {}_{} L ( θ , γ , O )}{\partial γ} {δ}_{γ} ;$$

and
calculate a derivative, with respect to γ, of log C(θ,γ), which is a logarithm of C(θ,γ), which is the normalizing constant C contained in the log L(θ,γ,O), the derivative being expressed as

$$\\ \frac{\partial 𝒞 ( θ , γ )}{\partial γ} \frac{1}{𝒞 ( θ , γ )} ,$$

by calculating the log C(θ,γ), which is the logarithm of the normalizing constant C(θ,γ), and a logarithm of a derivative of the normalizing constant C(θ,γ) expressed as

$$\\ log \frac{\partial 𝒞 ( θ , γ )}{\partial γ} ,$$

calculating the linear sum of the logarithm of the normalizing constant C(θ,γ) and the logarithm of the derivative of the normalizing constant C(θ,γ), the linear sum being expressed as

$$\\ - log 𝒞 ( θ , γ ) + log \frac{\partial 𝒞 ( θ , γ )}{\partial γ} ,$$

and
calculating the exponential function an exponent of which is the linear sum.

With this configuration, it is possible to stabilize numerical computations in estimating the parameters of the Fisher-Bingham distribution with use of a parameter γ.

### (Supplementary Note 4)

The information processing apparatus described in any one of supplementary notes 1 to 3, in which
the log C(θ,γ), which is the logarithm of the normalizing constant C(θ,γ), contains a sum of a plurality of complex terms, and
given that: the plurality of complex terms are expressed as zₙ (n is an index indicating each of the plurality of complex terms); amplitudes of the zₙ are expressed as Argzₙ; and an imaginary unit is expressed as i,
the estimating means is configured to
calculate the log C(θ,γ) by calculating a linear sum of
   log|z*|, which is a logarithm of an absolute value of z*, which is a complex term having a largest absolute value of the plurality of complex terms zₙ, and
   log Σ exp(log|zₙ|−log|z*|−iArgzₙ), which is a logarithm of a sum of exponential functions exponents of which are log|zₙ|−log|z*|−iArgzₙ.

With this configuration, it is possible to stabilize numerical computations involved in calculating the logarithm of the normalizing constant C(θ,γ).

### (Supplementary Note 5)

The information processing apparatus described in any one of supplementary notes 1 to 4, further including
a detecting means for referring to the parameters estimated by the estimating means to carry out a detecting process pertaining to the data set.

With this configuration, it is possible to stabilize numerical computations involved in the detecting process pertaining to the data set.

### (Supplementary Note 6)

An information processing apparatus including:
an acquiring means for acquiring a data set; and
a calculating means for calculating log F, which is a logarithm of a target function F that at least contains, as an argument thereof, a value contained in the data set and that contains a sum of a plurality of complex terms,
given that: the plurality of complex terms are expressed as zₙ (n is an index indicating each of the plurality of complex terms); amplitudes of the zₙ are expressed as Argzₙ; and an imaginary unit is expressed as i,
the calculating means being configured to
calculate the log F by calculating a linear sum of
   log|z*|, which is a logarithm of an absolute value of z*, which is a complex term having a largest absolute value of the plurality of complex terms zₙ, and
   log Σ exp(log|zₙ|−log|z*|−iArgzₙ), which is a logarithm of a sum of exponential functions exponents of which are log|zₙ|−log|z*|−iArgzₙ.

With this configuration, it is possible to stabilize numerical computations involved in calculating the logarithm of the target function.

### (Supplementary Note 7)

The information processing apparatus described in supplementary note 6, in which
the target function F is a normalizing constant of a Fisher-Bingham distribution which corresponds to the data set.

With this configuration, it is possible to stabilize numerical computations involved in calculating the logarithm of the normalizing constant of the Fisher-Bingham distribution.

### (Supplementary Note 8)

An information processing method including:
acquiring a data set; and
estimating parameters of a Fisher-Bingham distribution which corresponds to the data set,
the estimating parameters including:
   calculating a logarithm of a normalizing constant C of the Fisher-Bingham distribution and a logarithm of a derivative of the normalizing constant C;
   calculating a linear sum of the logarithm of the normalizing constant C and the logarithm of the derivative of the normalizing constant C; and
   calculating an exponential function an exponent of which is the linear sum.

This information processing method produces the same example advantage that is produced by the information processing apparatus described above.

### (Supplementary Note 9)

An information processing method including:
acquiring a data set; and
calculating log F, which is a logarithm of a target function F that at least contains, as an argument thereof, a value contained in the data set and that contains a sum of a plurality of complex terms, in which
given that: the plurality of complex terms are expressed as zₙ (n is an index indicating each of the plurality of complex terms); amplitudes of the zₙ are expressed as Argzₙ; and an imaginary unit is expressed as i,
in the calculating log F, the log F is calculated by calculating a linear sum of
   log|z*|, which is a logarithm of an absolute value of z*, which is a complex term having a largest absolute value of the plurality of complex terms zₙ, and
   log Σ exp(log|zₙ|−log|z*|−iArgzₙ), which is a logarithm of a sum of exponential functions exponents of which are log|zₙ|−log|z*|−iArgzₙ.

This information processing method produces the same example advantage that is produced by the information processing apparatus described above.

### (Supplementary Note 10)

A program for causing a computer to carry out:
an acquiring process of acquiring a data set; and
an estimating process of estimating parameters of a Fisher-Bingham distribution which corresponds to the data set,
the estimating process including:
   calculating a logarithm of a normalizing constant C of the Fisher-Bingham distribution and a logarithm of a derivative of the normalizing constant C;
   calculating a linear sum of the logarithm of the normalizing constant C and the logarithm of the derivative of the normalizing constant C; and
   calculating an exponential function an exponent of which is the linear sum.

This configuration produces the same example advantage that is produced by the information processing apparatus described above.

### (Supplementary Note 11)

A program for causing a computer to carry out:
an acquiring process of acquiring a data set; and
a calculating process of calculating log F, which is a logarithm of a target function F that at least contains, as an argument thereof, a value contained in the data set and that contains a sum of a plurality of complex terms, in which
given that: the plurality of complex terms are expressed as zₙ (n is an index indicating each of the plurality of complex terms); amplitudes of the zₙ are expressed as Argzₙ; and an imaginary unit is expressed as i,
in the calculating process, the log F is calculated by calculating a linear sum of
   log|z*|, which is a logarithm of an absolute value of z*, which is a complex term having a largest absolute value of the plurality of complex terms zₙ, and
   log Σ exp(log|zₙ|−log|z*|−iArgzₙ), which is a logarithm of a sum of exponential functions exponents of which are log|zₙ|−log|z*|−iArgzₙ.

This configuration produces the same example advantage that is produced by the information processing apparatus described above.

### [Additional Remark 3]

The whole or part of the example embodiments disclosed above can be further described as the following supplementary notes.

An information processing apparatus including at least one processor, the at least one processor carrying out: an acquiring process of acquiring a data set; and an estimating process of estimating parameters of a Fisher-Bingham distribution which corresponds to the data set, the estimating process including: calculating a logarithm of a normalizing constant C of the Fisher-Bingham distribution and a logarithm of a derivative of the normalizing constant C; calculating the linear sum of the logarithm of the normalizing constant C and the logarithm of the derivative of the normalizing constant C; and calculating an exponential function an exponent of which is the linear sum.

This information processing apparatus may further include a memory, and this memory may have stored therein a program for causing the at least one processor to carry out the acquiring process and the estimating process. In addition, a computer-readable, non-transitory, and tangible recording medium may have this program recorded thereon.

Additionally, the whole or part of the example embodiments disclosed above can be further described as the following supplementary notes.

An information processing apparatus configured to carry out: an acquiring process of acquiring a data set; and a calculating process of calculating log F, which is a logarithm of a target function F that at least contains, as an argument thereof, a value contained in the data set and that contains a sum of a plurality of complex terms, given that: the plurality of complex terms are expressed as zₙ (n is an index indicating each of the plurality of complex terms); amplitudes of the zₙ are expressed as Argzₙ; and an imaginary unit is expressed as i, the calculating process is a process of calculating the log F by calculating a linear sum of log|z*|, which is a logarithm of an absolute value of z*, which is a complex term having a largest absolute value of the plurality of complex terms zₙ, and log Σ exp(log|zₙ|−log|z*|−iArgzₙ), which is a logarithm of a sum of exponential functions exponents of which are log|zₙ|−log|z*|−iArgzₙ.

This information processing apparatus may further include a memory, and this memory may have stored therein a program for causing the at least one processor to carry out the acquiring process and the calculating process. In addition, a computer-readable, non-transitory, and tangible recording medium may have this program recorded thereon.

### REFERENCE SIGNS LIST

1, 1A, 2: Information processing apparatus
S1, S1A, S2: Information processing method
10A: Control section
11, 21: Acquiring section
12, 12A: Estimating section
13A: Detecting section
20A: Storage section
22: Calculating section
30A: Communication section
40A: Input-output section

What is claimed is:

1. An information processing apparatus comprising
at least one processor, the at least one processor carrying out:
an acquiring process of acquiring a data set; and
an estimating process of estimating parameters of a Fisher-Bingham distribution which corresponds to the data set, the estimating process including:
calculating a logarithm of a normalizing constant C of the Fisher-Bingham distribution and a logarithm of a derivative of the normalizing constant C;
calculating the linear sum of the logarithm of the normalizing constant C and the logarithm of the derivative of the normalizing constant C; and
calculating an exponential function an exponent of which is the linear sum.

2. The information processing apparatus according to claim 1, wherein in the estimating process, the at least one processor:
estimates the parameters by maximum likelihood estimation in which gradient method is used;
with use of a likelihood function L(θ,γ,O), updates θ, which is one of the parameters, by
$$\\ \hat{θ} = θ + \frac{\partial log {}_{} L ( θ , γ , O )}{\partial θ} {δ}_{θ} ;$$
and
calculates a derivative, with respect to θ, of log C(θ,γ), which is a logarithm of C(θ,γ), which is the normalizing constant C contained in the log L(θ,γ,O), the derivative being expressed as
$$\\ \frac{\partial 𝒞 ( θ , γ )}{\partial θ} \frac{1}{𝒞 ( θ , γ )} ,$$
by calculating the log C(θ,γ), which is the logarithm of the normalizing constant C(θ,γ), and a logarithm of a derivative of the normalizing constant C(θ,γ) expressed as
$$\\ log \frac{\partial 𝒞 ( θ , γ )}{\partial θ} ,$$
calculating the linear sum of the logarithm of the normalizing constant C(θ,γ) and the logarithm of the derivative of the normalizing constant C(θ,γ), the linear sum being expressed as
$$\\ - log 𝒞 ( θ , γ ) + log \frac{\partial 𝒞 ( θ , γ )}{\partial θ} ,$$
and
calculating the exponential function an exponent of which is the linear sum.

3. The information processing apparatus according to claim 1, wherein
in the estimating process, the at least one processor:
estimates the parameters by maximum likelihood estimation in which gradient method is used;
with use of a likelihood function L(θ,γ,O), updates γ, which is one of the parameters, by
$$\\ \hat{γ} = γ + \frac{\partial log {}_{} L ( θ , γ , O )}{\partial γ} {δ}_{γ} ;$$
and
calculates a derivative, with respect to γ, of log C(θ,γ), which is a logarithm of C(θ,γ), which is the normalizing constant C contained in the log L(θ,γ,O), the derivative being expressed as
$$\\ \frac{\partial 𝒞 ( θ , γ )}{\partial γ} \frac{1}{𝒞 ( θ , γ )} ,$$
by calculating the log C(θ,γ), which is the logarithm of the normalizing constant C(θ,γ), and a logarithm of a derivative of the normalizing constant C(θ,γ) expressed as
$$\\ log \frac{\partial 𝒞 ( θ , γ )}{\partial γ} ,$$
calculating the linear sum of the logarithm of the normalizing constant C(θ,γ) and the logarithm of the derivative of the normalizing constant C(θ,γ), the linear sum being expressed as
$$\\ - log 𝒞 ( θ , γ ) + log \frac{\partial 𝒞 ( θ , γ )}{\partial γ} ,$$
and
calculating the exponential function an exponent of which is the linear sum.

4. The information processing apparatus according to claim 1, wherein
the log C(θ,γ), which is the logarithm of the normalizing constant C(θ,γ), contains a sum of a plurality of complex terms, and
given that: the plurality of complex terms are expressed as zₙ (n is an index indicating each of the plurality of complex terms); amplitudes of the zₙ are expressed as Argzₙ; and an imaginary unit is expressed as i,
in the estimating process, the at least one processor
calculates the log C(θ,γ) by calculating a linear sum of
log|z*|, which is a logarithm of an absolute value of z*, which is a complex term having a largest absolute value of the plurality of complex terms zₙ, and
log Σ exp(log|zₙ|−log|z*|−iArgzₙ), which is a logarithm of a sum of exponential functions exponents of which are log|zₙ|−log|z*|−iArgzₙ.

5. The information processing apparatus according to claim 1, wherein
the at least one processor further carries out
a detecting process of referring to the parameters estimated in the estimating process to carry out a detecting process pertaining to the data set.

6. An information processing apparatus comprising
at least one processor, the at least one processor carrying out: an acquiring process of acquiring a data set; and
a calculating process of calculating log F, which is a logarithm of a target function F that at least contains, as an argument thereof, a value contained in the data set and that contains a sum of a plurality of complex terms,
given that: the plurality of complex terms are expressed as zₙ (n is an index indicating each of the plurality of complex terms); amplitudes of the zₙ are expressed as Argzₙ; and an imaginary unit is expressed as i,
in the calculating process, the at least one processor
calculates the log F by calculating a linear sum of
log|z*|, which is a logarithm of an absolute value of z*, which is a complex term having a largest absolute value of the plurality of complex terms zₙ, and
log Σ exp(log|zₙ|−log|z*|−iArgzₙ), which is a logarithm of a sum of exponential functions exponents of which are log|zₙ|−log|z*|−iArgzₙ.

7. The information processing apparatus according to claim 6, wherein
the target function F is a normalizing constant of a Fisher-Bingham distribution which corresponds to the data set.

8. An information processing method comprising:
acquiring a data set; and
estimating parameters of a Fisher-Bingham distribution which corresponds to the data set, the estimating parameters including:
calculating a logarithm of a normalizing constant C of the Fisher-Bingham distribution and a logarithm of a derivative of the normalizing constant C;
calculating a linear sum of the logarithm of the normalizing constant C and the logarithm of the derivative of the normalizing constant C; and
calculating an exponential function an exponent of which is the linear sum.

9. (canceled)

10. A computer-readable non-transitory recording medium having recorded thereon a program for causing a computer to function as the information processing apparatus according to claim 1, the program causing the computer to carry out the acquiring process and the estimating process.

11. A computer-readable non-transitory recording medium having recorded thereon a program for causing a computer to function as the information processing apparatus according to claim 6, the program causing the computer to carry out the acquiring process and the calculating process.
